(19) United States
(12) Patent Application Publication
(10) Pub. No.: US 2017/0069067 A1
(43) Pub. Date: Mar. 9, 2017

(54) IMAGE ADJUSTING METHOD, IMAGE ADJUSTING SYSTEM AND NON-TRANSITORY COMPUTER READABLE STORAGE MEDIUM

(71) Applicant: CHUNGHWA PICTURE TUBES, LTD., Taoyuan City (TW)

(72) Inventors: Chuan-Tsung SU, Taoyuan City (TW); Chun-Wei SU, New Taipei City (TW); Jan-Tian LIAN, Keelung City (TW)

(21) Appl. No.: 14/986,736

(22) Filed: Jan. 4, 2016

(30) Foreign Application Priority Data
Sep. 8, 2015 (CN) 201510565585.6

(51) Int. Cl. G06T 5/00; G09G 5/02; G09G 5/10

(52) U.S. Cl. CPC G06T 5/009; G09G 5/10; G09G 5/02; G06T 5/003; G06T 2207/20208; G09G 2320/066; G09G 2320/0626; G09G 2320/0673; G06T 2210/36

(57) ABSTRACT

An image adjusting method configured to adjust an original image on a transparent display device includes: adjusting a saturation level of the original image to generate a saturation optimization image; adjusting a contrast level of a first image associated with the saturation optimization image to generate a contrast optimization image; adjusting an exposure level of the contrast optimization image to generate an exposure optimization image; and adjusting a sharpness level of a second image associated with the exposure optimization image to generate an output image.

### RELATED APPLICATIONS

This application claims priority to Chinese Application Serial Number 201510565585.6, filed Sep. 8, 2015, which is herein incorporated by reference.

### BACKGROUND

1. Technical Field

The present disclosure relates to an image adjusting method, an image adjusting system and a non-transitory computer readable storage medium. More particularly, the present disclosure relates to an image adjusting method, an image adjusting system and a non-transitory computer readable storage medium that can be applied to a transparent display device.

2. Description of Related Art

The current technology is such that transparent display devices have been widely implemented on various transparent display windows. The transparent display devices adopt light from environment as light source. Because the light from environment compared with other light source (for example, backlight) is weaker, the image quality of an image displaying on a transparent display device is often worse.

### SUMMARY

One embodiment of the present disclosure is related to an image adjusting method. The image adjusting method is configured to adjust an original image on a transparent display device. The image adjusting method includes: adjusting a saturation level of the original image to generate a saturation optimization image; adjusting a contrast level of a first image associated with the saturation optimization image to generate a contrast optimization image; adjusting an exposure level of the contrast optimization image to generate an exposure optimization image; and adjusting a sharpness level of a second image associated with the exposure optimization image to generate an output image.

Another embodiment of the present disclosure is related to an image adjusting system. The image adjusting system is configured to adjust an original image on a transparent display device. The image adjusting system includes a saturation adjusting module, a contrast adjusting module, an exposure adjusting module and a sharpness adjusting module. The saturation adjusting module is configured to adjust a saturation level of the original image to generate a saturation optimization image. The contrast adjusting module is configured to adjust a contrast level of a first image associated with the saturation optimization image to generate a contrast optimization image. The exposure adjusting module is configured to adjust an exposure level of the contrast optimization image to generate an exposure optimization image. The sharpness adjusting module is configured to adjust a sharpness level of a second image associated with the exposure optimization image to generate an output image.

Yet another embodiment of the present disclosure is related to a non-transitory computer readable storage medium storing a computer program. The computer program is configured to execute an image adjusting method. The image adjusting method is configured to adjust an original image on a transparent display device. The image adjusting method includes: adjusting a saturation level of the original image to generate a saturation optimization image; adjusting a contrast level of a first image associated with the saturation optimization image to generate a contrast optimization image; adjusting an exposure level of the contrast optimization image to generate an exposure optimization image; and adjusting a sharpness level of a second image associated with the exposure optimization image to generate an output image.

In view of the above, by applying one of the above embodiments, the image adjusting method and the image adjusting system sequentially adjust a saturation level, a contrast level, an exposure level and a sharpness level of an image on a transparent display device to improve a quality of the image on the transparent display device.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a flow diagram illustrating an image adjusting method according to one embodiment of the present disclosure;

FIG. 2 is a block diagram illustrating an image adjusting system according to one embodiment of this disclosure;

FIG. 3 is a flow diagram illustrating an image adjusting method according to another embodiment of this disclosure;

FIG. 4 is a flow diagram illustrating an image adjusting method according to yet another embodiment of this disclosure;

FIG. 5 is a block diagram illustrating an image adjusting system according to yet another embodiment of this disclosure;

FIG. 6 is a flow diagram illustrating an image adjusting method according to still another embodiment of this disclosure; and

FIG. 7 is a block diagram illustrating a transparent display device according to one embodiment of this disclosure.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

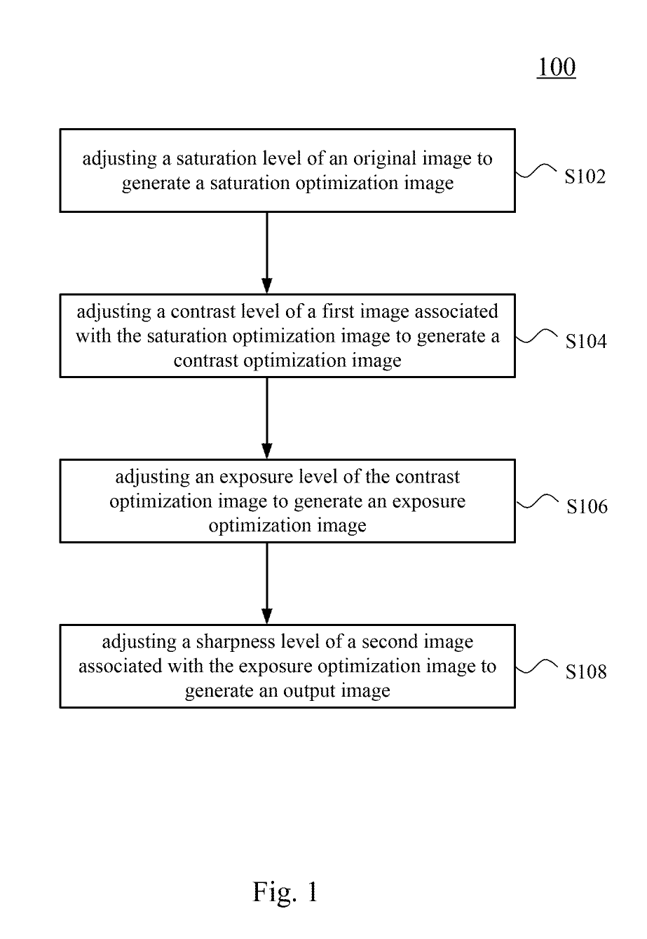

FIG. 1 is a flow diagram illustrating an image adjusting method 100 according to one embodiment of the present disclosure. The image adjusting method 100 is configured to adjust an original image on a transparent display device. The transparent display device can be applied to car apparatus, military apparatus, exercise apparatus, entertainment apparatus, security apparatus or other apparatus. The original image can be a photo or a video. As illustrated in FIG. 1, the image adjusting method 100 includes steps S102-S108.

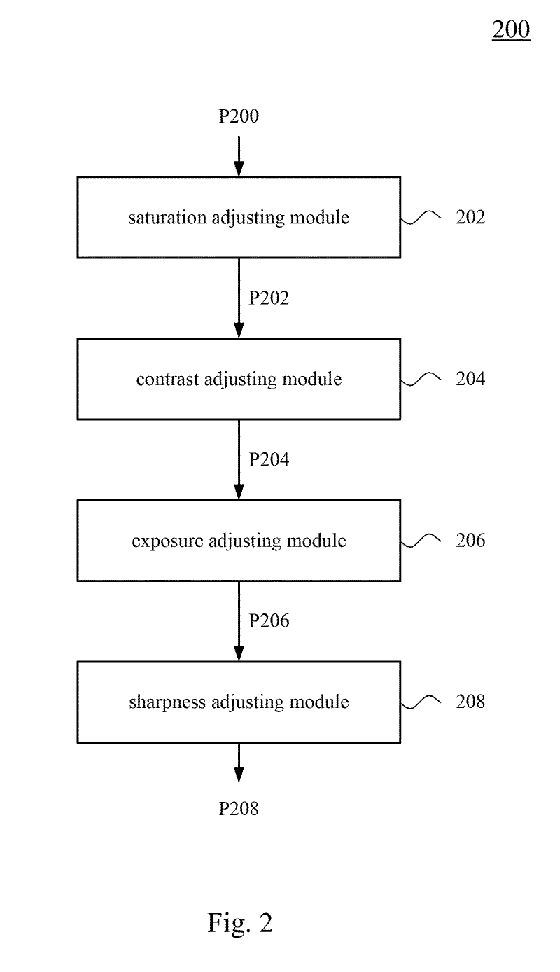

FIG. 2 is a block diagram illustrating an image adjusting system 200 according to one embodiment of this disclosure. The image adjusting system 200 is configured to execute the image adjusting method 100 illustrated in FIG. 1. As illustrated in FIG. 2, the image adjusting system 200 includes a saturation adjusting module 202, a contrast adjusting module 204, an exposure adjusting module 206 and a sharpness adjusting module 208.

At first, an original image P200 on a transparent display device is input into the image adjusting system 200.

As illustrated in FIG. 1 and FIG. 2, in step S102, the saturation adjusting module 202 adjusts a saturation level of the original image P200 to generate a saturation optimization image P202. When a saturation level of an image is higher, a vivid level of the image is higher. In some embodiments, the saturation adjusting module 202 can provide an adjustable range for the saturation level, such as from −100 to 100. A user can input a particular value within the adjustable range through an operation interface (for example a website or a graphic user interface etc.) to adjust the saturation level of the original image P200. However, in order to get a better image, the saturation adjusting module 202 can further provide a recommendation range, such as from 90 to 100, to recommend the user a better saturation range. In some other embodiments, instead of setting a saturation value by the user, the saturation adjusting module 202 can directly adjust the original image P200 to be a plurality of images with different saturation level. These images are displayed on the operation interface. The user can choose one of the images which he thinks the best one as the saturation optimization image P202 after he sees these images.

Then, in step S104, the contrast adjusting module 204 adjusts a contrast level of a first image associated with the saturation optimization image P202 to generate a contrast optimization image P204. In this embodiment, the first image is the saturation optimization image P202. In other words, in step S104, the contrast adjusting module 204 adjusts a contrast level of the saturation optimization image P202. When a contrast level of an image is higher, a color scale level of the image is more obvious. In some embodiments, the contrast adjusting module 204 can provide an adjustable range for the contrast level, such as from −25 to 100. A user can input a particular value within the adjustable range through an operation interface to adjust the contrast level of the saturation optimization image P202. However, in order to get a better image, the contrast adjusting module 204 can further provide a recommendation range, such as from 75 to 100, to recommend the user a better contrast range. In some other embodiments, instead of setting a contrast value by the user, the contrast adjusting module 204 can adjust the saturation optimization image P202 to be a plurality of images with different contrast level. These images are displayed on the operation interface. The user can choose one of the images which he thinks the best one as the contrast optimization image P204 after he sees these images.

Then, in step S106, the exposure adjusting module 206 adjusts an exposure level of the contrast optimization image P204 to generate an exposure optimization image P206. When an exposure level of an image is higher, a planar brightness level of the image is higher. In some embodiments, the exposure adjusting module 206 can provide an adjustable range for the exposure level, such as from −9 to 9. A user can input a particular value within the adjustable range through an operation interface to adjust the exposure level of the contrast optimization image P204. However, in order to get a better image, the exposure adjusting module 206 can further provide a recommendation range, such as from 1 to 6, to recommend the user a better exposure range. In some other embodiments, instead of setting an exposure value by the user, the exposure adjusting module 206 can adjust the contrast optimization image P204 to be a plurality of images with different exposure level. These images are displayed on the operation interface. The user can choose one of the images which he thinks the best one as the exposure optimization image P206 after he sees these images.

Then, in step S108, the sharpness adjusting module 208 adjusts a sharpness level of a second image associated with the exposure optimization image P206 to generate an output image P208. In this embodiment, the second image is the exposure optimization image P206. In other words, in step S108, the sharpness adjusting module 208 adjusts a sharpness level of the exposure optimization image P206. When a sharpness level of an image is higher, a distinguishable level between different layers in the image is higher. In some embodiments, the sharpness adjusting module 208 can provide an adjustable range for the sharpness level, for example from 0.1 to 64. A user can input a particular value within the adjustable range through an operation interface to adjust the sharpness level of the exposure optimization image P206. However, in order to get a better image, the sharpness adjusting module 208 can further provide a recommendation range, for example from 30 to 60, to recommend the user a better sharpness range. In some other embodiments, instead of setting a sharpness value by the user, the sharpness adjusting module 208 can adjust the exposure optimization image P206 to be a plurality of images with different sharpness level. These images are displayed on the operation interface. The user can choose one of the images which he thinks the best one as an output image P208 after he sees these images.

In the embodiments above, the image adjusting method 100 can sequentially adjust a saturation level, a contrast level, a exposure level and a sharpness level of an image on a transparent display device to improve a quality of the image on the transparent display device.

In some embodiments, the saturation adjusting module 202, the contrast adjusting module 204, the exposure adjusting module 206 and the sharpness adjusting module 208 of the image adjusting system 200 can be implemented by firmware. Compared to hardware circuit, firmware is more flexible for design and can give consideration to executing speed and accuracy.

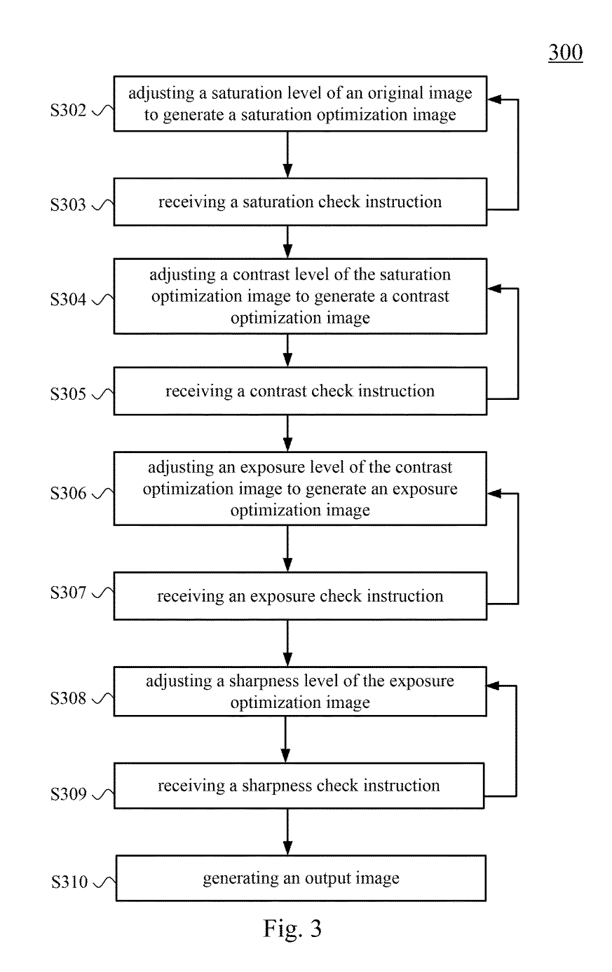

FIG. 3 is a flow diagram illustrating an image adjusting method 300 according to another embodiment of this disclosure. Steps S302, S304, S306, S308 and S310 are substantially similar to the steps S102, S104, S106 and S108. However, the image adjusting method 300 further comprises steps S303, S305, S307 and S309.

As illustrated in FIG. 2 and FIG. 3 in some embodiments, the image adjusting method 300 can further comprise step S303. Step S303 is configured for receiving a saturation check instruction. For example, after the saturation adjusting module 202 adjusts a saturation level of an original image P200, the saturation optimization image P202 can be displayed on an operation interface (for example a website or a graphic user interface etc.) to be confirmed by the user. If the user thinks the saturation optimization image P202 is good, the user can, for example, press a “confirm” button on the operation interface to continue to adjust the contrast level of the saturation optimization image P202. On the contrary, if the user thinks the saturation optimization image P202 is not good, the user can, for example, press a “readjust” button on the operation interface to readjust the saturation level of the original image P200. The image adjusting system 200 will receive the saturation check instruction (“confirm” or “readjust”) due to the user's operation described above (press the “confirm” button or press the “readjust” button). The image adjusting system 200 will continue to adjust a contrast level of the saturation optimization image P202 (step S304) or readjust the saturation level of the original image P200 (step S302) according to the saturation check instruction.

In some embodiments, the image adjusting method 300 can further include step S305. Step S305 is configured for receiving a contrast check instruction. Step S305 is similar to Step S303. For example, if the user thinks the contrast optimization image P204 is good, the user can, for example, press a “confirm” button on an operation interface. On the contrary, if the user thinks the contrast optimization image P204 is not good, the user can, for example, press a “readjust” button on the operation interface. The image adjusting system 200 will receive the contrast check instruction (“confirm” or “readjust”) due to the user's operation described above (press the “confirm” button or press the “readjust” button). The image adjusting system 200 will continue to adjust an exposure level of the contrast optimization image P204 (step S306) or readjust the contrast level of the saturation optimization image P202 (step S304) according to the contrast check instruction.

In some embodiments, the image adjusting method 300 can further include step S307. Step S307 is configured for receiving an exposure check instruction. Step S307 is similar to Step S305. For example, if the user thinks the exposure optimization image P206 is good, the user can, for example, press a “confirm” button on an operation interface. On the contrary, if the user thinks the exposure optimization image P206 is not good, the user can, for example, press a “readjust” button on the operation interface. The image adjusting system 200 will receive the exposure check instruction (“confirm” or “readjust”) due to the user's operation described above (press the “confirm” button or press the “readjust” button). The image adjusting system 200 will continue to adjust a sharpness level of the exposure optimization image P206 (step S308) or readjust the exposure level of the contrast optimization image P204 (step S306) according to the exposure check instruction.

In some embodiments, the image adjusting method 300 can further include step S309. Step S309 is configured for receiving a sharpness check instruction. Step S309 is similar to Step S307. For example, if the user thinks the sharpness optimization image is good, the user can, for example, press a “confirm” button on an operation interface to output the output image P208. The output image P208 is the sharpness optimization image. On the contrary, if the user thinks the sharpness optimization image is not good, the user can, for example, press a “readjust” button on the operation interface. The image adjusting system 200 will receive the sharpness check instruction (“confirm” or “readjust”) due to the user's operation described above (press the “confirm” button or press the “readjust” button). The image adjusting system 200 will generate the output image P208 (step S310) or readjust the sharpness level of the exposure optimization image P206 (step S308) according to the sharpness check instruction.

In the embodiments above, according to the saturation check instruction, the contrast check instruction, the exposure check instruction and the sharpness check instruction, the image adjusting method 300 can confirm adjusting results of images in each step and determine to execute a next step or not. Consequently, the image on the transparent display device can be adjusted to be close to a better image user thinks.

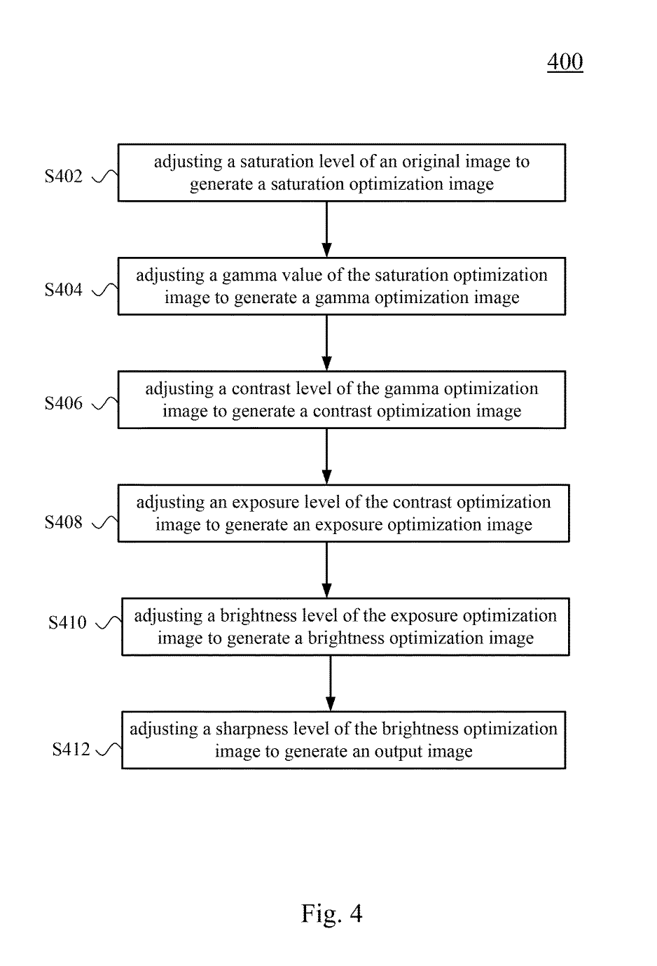

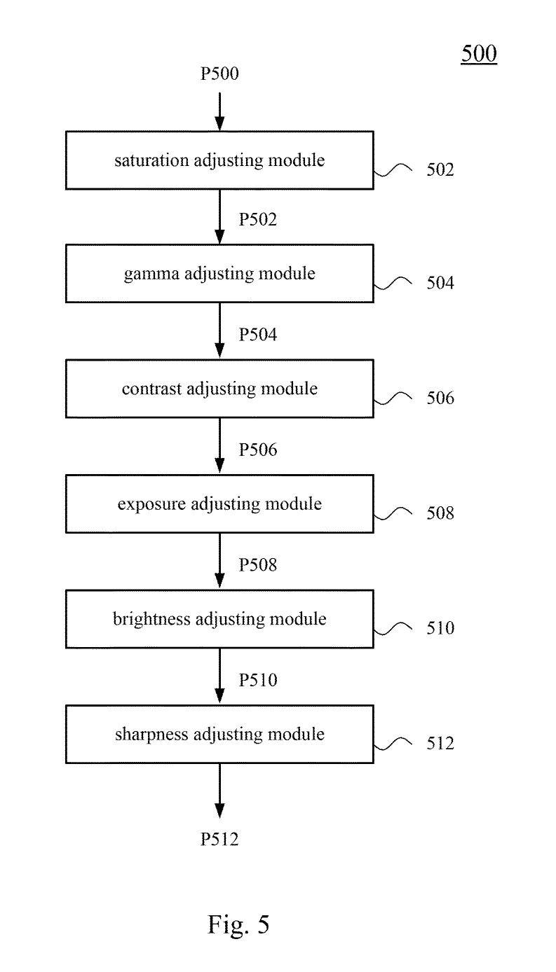

FIG. 4 is a flow diagram illustrating an image adjusting method 400 according to yet another embodiment of this disclosure. The image adjusting method 400 comprises steps S404, S406, S408, S410 and S412. FIG. 5 is a block diagram illustrating an image adjusting system 500 according to yet another embodiment of this disclosure. The image adjusting system 500 is configured to execute the image adjusting method 400 as illustrated in FIG. 4. The image adjusting system 500 also includes a saturation adjusting module 502, a contrast adjusting module 506, an exposure adjusting module 508 and a sharpness adjusting module 512. In some embodiments, the image adjusting system 500 can further comprises a gamma adjusting module 504. Moreover, in some embodiments, the image adjusting system 500 can further comprises a brightness adjusting module 510.

In some embodiments, the gamma adjusting module 504 and the brightness adjusting module 510 described above can also be implemented by firmware.

As illustrated in FIG. 4 and FIG. 5, in step S402, the saturation adjusting module 502 adjusts a saturation level of an original image P500 to generate a saturation optimization image P502.

In step S404, the gamma adjusting module 504 adjusts a gamma value of the saturation optimization image P502 to generate a gamma optimization image P504. A gamma value of an image is configured to define a brightness-gray level curve. In some embodiments, the gamma adjusting module 504 can provide an adjustable range for the gamma value, for example from 1.0 to 2.5. However, in order to get a better image, the gamma adjusting module 504 can further provide a recommendation range, for example from 1.5 to 2.5, to recommend an user a better gamma value range.

In step S406, the contrast adjusting module 506 adjusts a contrast level of the gamma optimization image P504 to generate a contrast optimization image P506.

In step S408, the exposure adjusting module 508 adjusts an exposure level of the contrast optimization image P506 to generate an exposure optimization image P508.

In step S410, the brightness adjusting module 510 adjusts a brightness level of the exposure optimization image P508 to generate a brightness optimization image P510. When a brightness level of an image is higher, a color level of the image is more whiten. In some embodiments, the brightness adjusting module 510 can provide an adjustable range for the brightness level, for example from −2.5 to 140. However, in order to get a better image, the brightness adjusting module 510 can further provide a recommendation range, for example from 10 to 50, to recommend a user a better brightness level range.

In step S412, the sharpness adjusting module 512 adjusts a sharpness level of the brightness optimization image P510 to generate an output image P512.

In the embodiments above, the image adjusting method 400 can sequentially adjust a saturation level, a gamma value, a contrast level, an exposure level, a brightness level and a sharpness level of an image on a transparent display device to improve a quality of the image on the transparent display device.

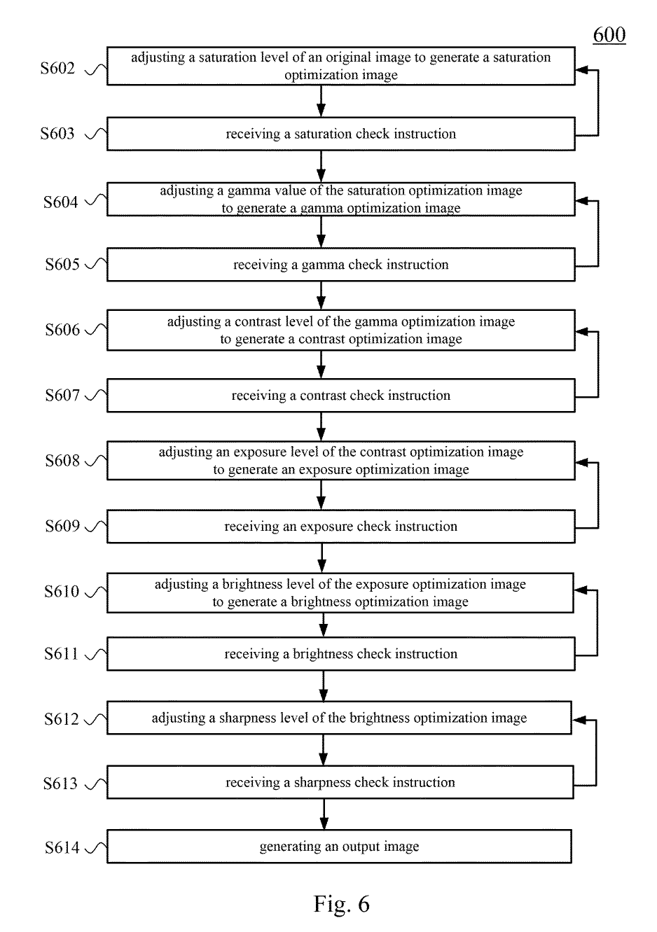

FIG. 6 is a flow diagram illustrating an image adjusting method 600 according to still another embodiment of this disclosure. Steps S602, S604, S606, S608, S610, S612 and S614 of the image adjusting method 600 as illustrated in FIG. 6 is substantially similar to steps S402, S404, S406, S408, S410 and S412 of the image adjusting method 400 as illustrated in FIG. 4. In some embodiments, the image adjusting method 600 can further comprises steps S603, S605, S607, S609, S611 or S613.

Moreover, the image adjusting method 600 of FIG. 6 is similar to the image adjusting method 300 of FIG. 3. As illustrated in FIG. 5 and FIG. 6, in step S603, after the saturation adjusting module 502 adjusts a saturation level of an original image P500, the image adjusting system 500 will continue to adjust a gamma value of a saturation optimization image P502 (step S604) or readjust the saturation level of the original image P500 (step S602) according to a saturation check instruction. In step S605, after the gamma adjusting module 504 adjusts the gamma value of the saturation optimization image P502, the image adjusting system 500 will continue to adjust a contrast level of a gamma optimization image P504 (step S606) or readjust the gamma value of the saturation optimization image P502 (step S604) according to a gamma check instruction. In step S607, after the contrast adjusting module 506 adjusts the contrast level of the gamma optimization image P504, the image adjusting system 500 will continue to adjust an exposure level of a contrast optimization image P506 (step S608) or readjust the contrast value of the gamma optimization image P504 (step S606) according to a contrast check instruction. In step S609, after the exposure adjusting module 508 adjusts the exposure level of the contrast optimization image P506, the image adjusting system 500 will continue to adjust a brightness level of an exposure optimization image P508 (step S610) or readjust the exposure level of the contrast optimization image P506 (step S608) according to an exposure check instruction. In step S611, after the brightness adjusting module 510 adjusts the brightness level of the exposure optimization image P508, the image adjusting system 500 will continue to adjust a sharpness level of a brightness optimization image P510 (step S612) or readjust the brightness level of the exposure optimization image P508 (step S610) according to a brightness check instruction. In step S613, after the sharpness adjusting module 512 adjusts the sharpness level of the brightness optimization image P510, the image adjusting system 500 will continue to output an output image P512 (step S614) or readjust the sharpness level of the brightness optimization image P510 (step S612) according to a sharpness check instruction.

A detailed description about the check instructions described above can refer to paragraph about FIG. 3. The detailed description in this regard will not be provided here.

In the embodiments above, according to the saturation check instruction, the gamma check instruction, the contrast check instruction, the exposure check instruction, the brightness check instruction and the sharpness check instruction, the image adjusting method 600 can confirm adjusting results of images in each step and determine to execute a next step or not. Consequently, the image on the transparent display device can be adjusted to be close to a better image user thinks.

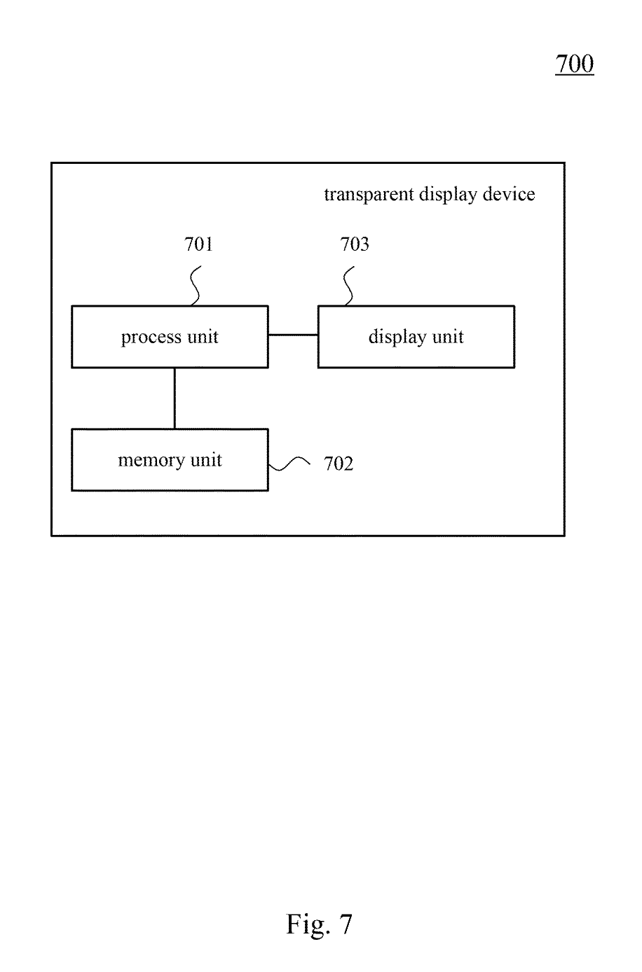

FIG. 7 is a block diagram illustrating a transparent display device 700 according to one embodiment of this disclosure. As illustrated in FIG. 7, the transparent display device 700 includes a process unit 701, a memory unit 702 and a display unit 703. The process unit 701 is coupled with the memory unit 702 and the display unit 703. The process unit 701 can be a central processing unit (CPU), a control unit, a micro processor or other hardware elements which can execute instructions. In some embodiments, the saturation adjusting module 202 or 502, the contrast adjusting module 204 or 506, the exposure adjusting module 206 or 508, the sharpness adjusting module 208 or 512, the gamma adjusting module 504 or the brightness adjusting module 510 can be implemented as program code. The program code can be stored in the memory unit 702. The memory unit 702 can be a non-transitory computer readable storage medium. The non-transitory computer readable storage medium comprises CD-ROM, DVD-ROM, EPROM, EEPROM, CD, DVD, a flash memory device, a magnetic disk or other non-transitory computer readable storage medium with similar function. The process unit 701 reads and executes the program code in the memory unit 702 to provide corresponding function of each module described above. The original image P200 and P500, the saturation optimization image P202 or P502, the contrast optimization image P204 or P506, the exposure optimization image P206 or P508, the gamma optimization image P504, the brightness optimization image P510 or output image P208 or P512 can be displayed on the display unit 703.

In view of the above, by applying one of the above embodiments, the image adjusting method and the image adjusting system sequentially adjust a saturation level, a contrast level, an exposure level and a sharpness level of an image on a transparent display device to improve a quality of the image on the transparent display device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An image adjusting method configured to adjust an original image on a transparent display device comprises:
adjusting a saturation level of the original image to generate a saturation optimization image;
adjusting a contrast level of a first image associated with the saturation optimization image to generate a contrast optimization image ;
adjusting an exposure level of the contrast optimization image to generate an exposure optimization image; and
adjusting a sharpness level of a second image associated with the exposure optimization image to generate an output image.

2. The image adjusting method of claim 1, wherein the first image is the saturation optimization image, and the second image is the exposure optimization image.

3. The image adjusting method of claim 1, further comprising:
receiving a saturation check instruction; and
adjusting the contrast level of the first image associated with the saturation optimization image or readjusting the saturation level of the original image according to the saturation check instruction.

4. The image adjusting method of claim 1, further comprising:
receiving a contrast check instruction; and
adjusting the exposure level of the contrast optimization image or readjusting the contrast level of the saturation optimization image according to the contrast check instruction.

5. The image adjusting method of claim 1, further comprising:
receiving an exposure check instruction; and
adjusting the sharpness level of the second image associated with the exposure optimization image or readjusting the exposure level of the contrast optimization image according to the exposure check instruction.

6. The image adjusting method of claim 1, further comprising:
receiving a sharpness check instruction; and
generating the output image or readjusting the sharpness level of the exposure optimization image according to the sharpness check instruction.

7. The image adjusting method of claim 1, further comprising:
adjusting a gamma value of the saturation optimization image to generate a gamma optimization image, wherein the gamma optimization image is the first image.

8. The image adjusting method of claim 7, further comprising:
receiving a gamma check instruction; and
adjusting the contrast level of the gamma optimization image or readjusting the gamma value of the saturation optimization image according to the gamma check instruction.

9. The image adjusting method of claim 1, further comprising:
adjusting a brightness level of the exposure optimization image to generate a brightness optimization image, wherein the brightness optimization image is the second image.

10. The image adjusting method of claim 9, further comprising:
receiving a brightness check instruction; and
adjusting the sharpness level of the brightness optimization image or readjusting the brightness level of the exposure optimization image according to the brightness check instruction.

11. An image adjusting system configured to adjust an original image on a transparent display device comprises:
a saturation adjusting module configured to adjust a saturation level of the original image to generate a saturation optimization image;
a contrast adjusting module configured to adjust a contrast level of a first image associated with the saturation optimization image to generate a contrast optimization image;
an exposure adjusting module configured to adjust an exposure level of the contrast optimization image to generate an exposure optimization image; and
a sharpness adjusting module configured to adjust a sharpness level of a second image associated with the exposure optimization image to generate an output image.

12. The image adjusting system of claim 11, wherein the first image is the saturation optimization image, and the second image is the exposure optimization image.

13. The image adjusting system of claim 11, wherein the image adjusting system is implemented by firmware.

14. The image adjusting system of claim 11, further comprising:
a gamma adjusting module configured to adjust a gamma value of the saturation optimization image to generate a gamma optimization image, wherein the gamma optimization image is the first image.

15. The image adjusting system of claim 11, further comprising:
a brightness adjusting module configured to adjust a brightness level of the exposure optimization image to generate a brightness optimization image, wherein the brightness optimization image is the second image.

16. A non-transitory computer readable storage medium storing a computer program, wherein the computer program is configured to execute an image adjusting method, the image adjusting method is configured to adjust an original image on a transparent display device, and the image adjusting method comprises:
adjusting a saturation level of the original image to generate a saturation optimization image;
adjusting a contrast level of a first image associated with the saturation optimization image to generate a contrast optimization image ;
adjusting an exposure level of the contrast optimization image to generate an exposure optimization image; and
adjusting a sharpness level of a second image associated with the exposure optimization image to generate an output image.

17. The non-transitory computer readable storage medium of claim 16, wherein the first image is the saturation optimization image, and the second image is the exposure optimization image.

18. The non-transitory computer readable storage medium of claim 16, wherein the image adjusting method further comprises:
receiving a saturation check instruction; and
adjusting the contrast level of the first image associated with the saturation optimization image or readjusting the saturation level of the original image according to the saturation check instruction.

19. The non-transitory computer readable storage medium of claim 16, wherein the image adjusting method further comprises:
adjusting a gamma value of the saturation optimization image to generate a gamma optimization image, wherein the gamma optimization image is the first image.

20. The non-transitory computer readable storage medium of claim 16, wherein the image adjusting method further comprises:
adjusting a brightness level of the exposure optimization image to generate a brightness optimization image, wherein the brightness optimization image is the second image.
